(19) United States
(12) Patent Application Publication
(10) Pub. No.: US 2001/0011804 A1
(43) Pub. Date: Aug. 9, 2001

(54) Air bag for sprint car

(76) Inventors: Curtis S. Bradshaw, Schenectady, NY (US); Curtis M. Bradshaw, Schenectady, NY (US)

Correspondence Address: Richard C. Litman, P.O. Box 15035, Crystal City Station, Arlington, DC, 22215-0035, US

(21) Appl. No.: 09/803,911

(22) Filed: Mar. 13, 2001

Related U.S. Application Data
(62) Division of application No. 09/433,711, filed on Nov. 4, 1999.
(60) Provisional application No. 60/110,481, filed on Dec. 1, 1998.

(51) Int. Cl. B60G 1/00

(52) U.S. Cl. 280/124.157; 280/124.1

(57) ABSTRACT

A first embodiment of a vehicle air bag spring suspension system utilizing a swing arm as a member of a four-bar linkage subsystem wherein the suspension system with the airbag spring is compressed by the linkage opposite the swing arm's fulcral point relative the supported wheel. The air bag further serves as an inherently, partially dampened spring having a non-linear spring compression rate, so as to firmly keep the vehicle tires firmly planted to a rough surface, with the system further benefitting from both the reduced total and unsprung weight of the air bag system and the higher frequency response of the air bag spring. A second embodiment employs two actuator arms per wheel, wherein one inside actuator arm contacts a fixed air bag spring and cooperates with the other outside actuator arm and a rotating actuator shaft inside a frame tube to dampen wheel movement.

### CROSS-REFERENCE TO RELATED APPLICATION

This application claims the benefit of U.S. Provisional Patent Application Serial No. 60/110,481, filed Dec. 1, 1998.

### BACKGROUND OF THE INVENTION

1. FIELD OF THE INVENTION

The present invention relates to two vehicle suspension systems incorporating an air bag in lieu of springs, torsion bars or coil-over design, with (1) the air bag compressed by a linkage on the opposite end of a swing arm's fulcral point from the supported wheel and (2) two cooperating actuator arms and a rotating actuator shaft compressing an air bag for each wheel.

2. DESCRIPTION OF RELATED ART

Sprint cars and other open wheeled race cars typically use a swing arm suspension. A representative view is shown in FIG. 3, wherein a rear axle 180 has a carrier hub 310 connecting the suspension to the wheel. One end of the swing arms 140 and 350 is attached to a torsion bar 320 and the other end attached to a means of supporting a wheel, such as a carrier hub 310 on a live axle or the axle itself on a fixed axle. The torsion bar 320 is typically housed within a tubing in the frame 330. The carrier hub 310 is attached to a swing arm 140 which is connected to a torsion bar 320. If only one swing arm is utilized, the swing arm 140 may lead or trail its associated axle. Supplemental suspension linkages may or may not be present for additional support to the axle 180.

Exemplary patents of various suspension systems include U.S. Pat. No. 3,822,908 issued on Jul. 9, 1974, to Rene Gouirand which describes a suspension system using single or dual air bags having a tapered cross-section in the truck's longitudinal direction and supported by an upper plate and a pair of lower lever members or axle supports. The air bags are pressurized by an air pump.

U.S. Pat. No. 4,733,876 issued on Mar. 29, 1988, to Merle J. Heider et al. describes a leaf spring supplemented with a pressure controllable air bag supplying variable spring adjustment, variable ride height, and stationary levelling of a motor home.

U.S. Pat. No. 4,858,949 issued on Aug. 22, 1989, to Donovan B. Wallace et al. describes a trailing arm suspension with a cup and piston air spring.

U.S. Pat. No. 4,923,210 issued on May 8, 1990, to Merle J. Heider et al. describes a leaf spring in conjunction with an air bag for motorhome levelling.

U.S. Pat. No. 5,265,907 issued on Nov. 30, 1993, to Ray Tostado describes a bolt on auxiliary air bag suspension system, wherein the frame takes existing apertures provided in certain trucks, resulting in a removable supplemental suspension system that assists the factory suspension system.

U.S. Pat. No. 5,346,246 issued on Sep. 13, 1994, to Cecil Lander et al. describes an air bag suspension controller for adjustment of spring rates of an air bag coupled in parallel with a leaf spring.

U.S. Pat. No. 5,366,238 issued on Nov. 22, 1994, to Donald L. Stephens describes a trailing arm suspension system having a tapered arm at a pivoting end so as to reduce arm weight in conjunction with an air spring at the opposite end.

U.S. Pat. No. 5,584,497 issued on Dec. 17, 1996, to Cecil Lander et al. describes an air bag suspension controller for adjustment of spring rates of an air bag coupled in parallel with a leaf spring.

U.S. Pat. No. 5,649,719 issued on Jul. 22, 1997, to Gareth A. Wallace et al. describes a weight-reducing, z-spring alternative in the form of an arm linkage and suspension system for heavy-weight bearing vehicles featuring upper arms y-mounted to the frame sides and the axle center.

Canadian Patent No. 492,516 issued on May 5, 1953, to Ernest E. Smith et al. describes a suspension system with an inelastic yet flexible inflatable conduit providing an air cushion.

Netherlands Patent No. 7,612,924 issued on May 23, 1978, to Dr. S. Rosenthal describes a swing arm suspension system having an air spring with the wheel situated at a fulcral point.

German Patent Application No. 39 34 238 A1 published on Apr. 4, 1991, for Audi AG (Heinz Hollerweger et al.) describes a hydraulic suspension pressure control system for oversteer or understeer control.

None of the above inventions and patents, taken either singly or in combination, is seen to describe the instant invention as claimed.

### SUMMARY OF THE INVENTION

The present invention relates to the field of vehicle suspension systems, specifically an air bag spring-dampener on (1) a swing arm suspension with the spring-axle connected via a four bar linkage and (2) two actuator arms and a rotating actuator shaft, wherein the air bag spring replaces traditional torsion bars or coil springs. Such systems are particularly suitable for use on race cars on dirt or rough surfaces, more specifically on open wheeled sprint, midget, micro-sprint, mini-sprints, championship dirt cars, micro-midgets, super-modifieds, championship dirt cars, and well suited for heavier cars such as modified-race cars. In competition, such race cars endure severe forces often resulting in loss of wheel to road surface contact, and resulting loss of traction, control and speed.

Accordingly, it is a principal object of the invention to provide an improved lightweight suspension system for a racing vehicle on a dirt track.

It is another object of the invention to provide an improved suspension system which is adjustable and non-linear in compression so as to provide an inherently damped system.

It is a further object of the invention to provide an improved suspension system having components sufficiently modular as to make the components readily replaceable.

Still another object of the invention is to reduce the amount of unsprung weight on a vehicle by using components lighter than coil or torsion springs.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a first embodiment of an air bag suspension installed for a rear axle of a sprint race car shown in shadow according to the present invention.

FIG. 2 is a partially sectioned side elevational view of an air bag draped over its shaping cone and in contact with a four bar linkage.

FIG. 3 is a perspective view of a swing arm suspension utilizing torsion bar springs in a prior art sprint car shown in shadow.

FIG. 4 is a top plan view of a sprint car shown in shadow equipped with four air bag springs and bar linkages.

FIG. 5 is a sectional side view of a prior art air bag spring as described by FIG. 8 in U.S. Pat. No. 4,858,949 to Wallace et al.

FIG. 6 is a sectional side view of a prior art GOODYEAR™ air bag spring 1S6-023.

FIG. 7 is a partially sectioned side view showing direction of motion and forces of an air bag spring being compressed by upward forces acting upon a wheel.

FIG. 8 is a side view showing direction of motion and forces acting upon a wheel being pushed down by an air bag spring.

FIG. 9 is a right side elevational view of a sprint car with a second embodiment of the innovative air springs installed in the front and rear.

FIG. 10 is a front elevational view of the innovative air springs for the front axle of a sprint car.

FIG. 11 is a rear elevational view of the innovative air springs for the rear axle in a sprint car.

FIG. 12 is an elevational side view of an actuator shaft for the second embodiment.

Similar reference characters denote corresponding features consistently throughout the attached drawings.

### DETAILED DESCRIPTION OF THE PREFERRED EMBODIMENTS

The first embodiment 8 of the present system incorporates a four-bar linkage system, connecting an axle swing arm suspension system to an air bag spring dampening system.

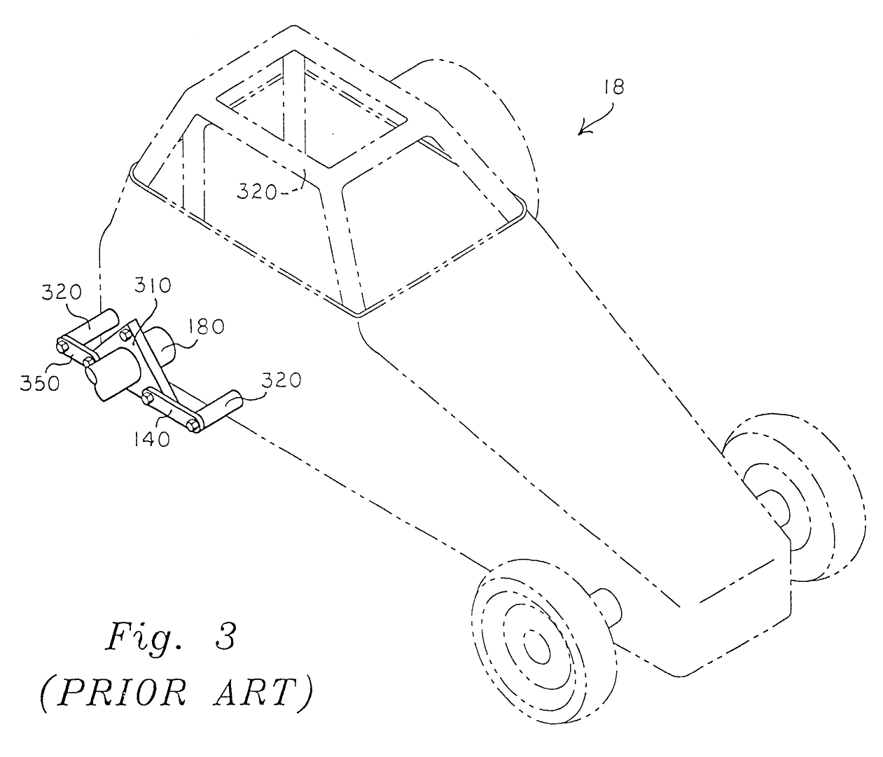

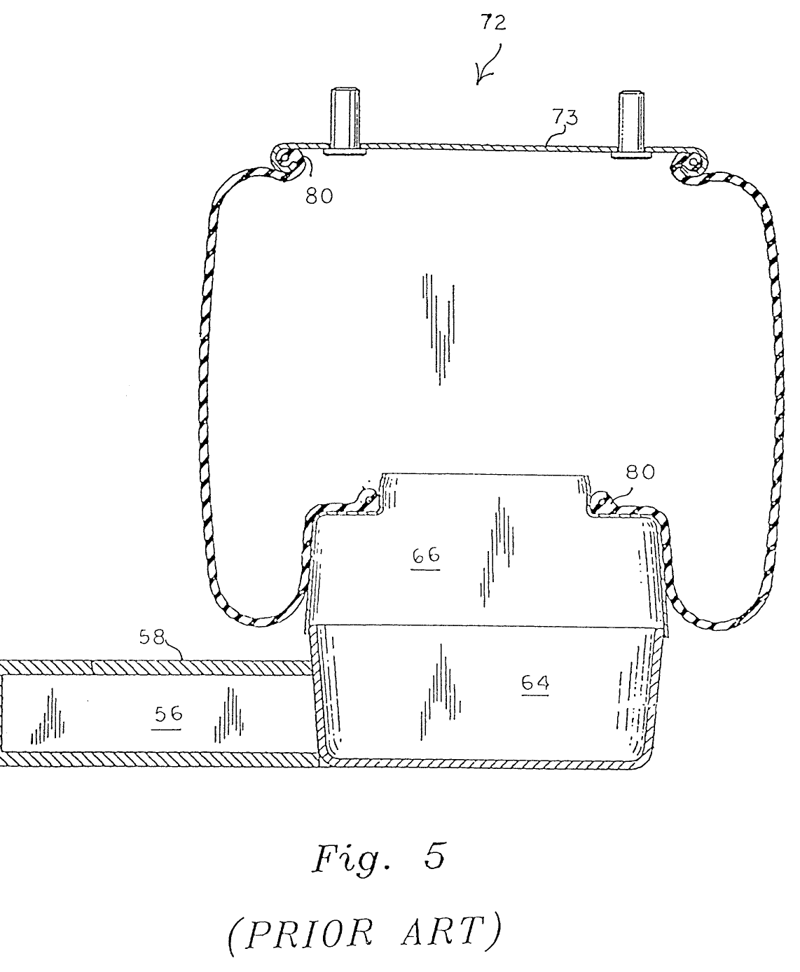

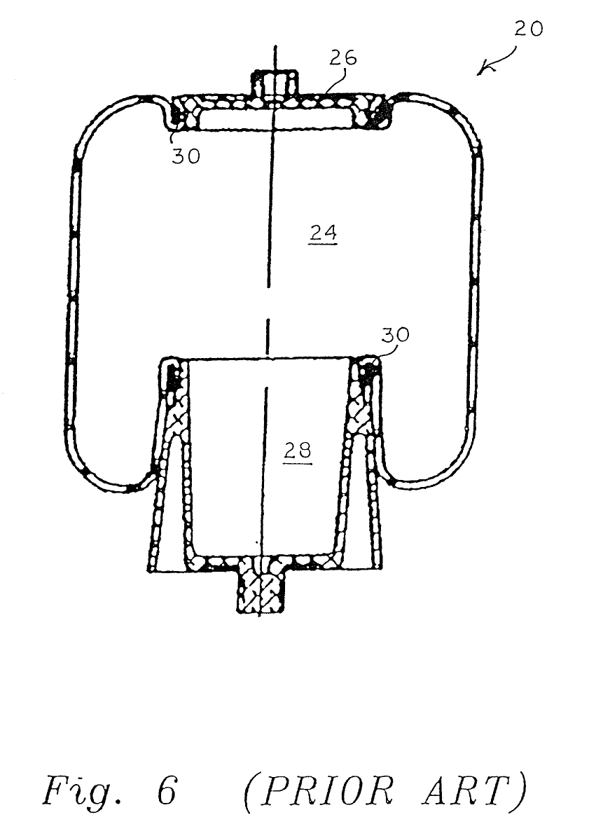

FIGS. 3, 5 and 6 depict prior art suspension systems with air bag springs. In FIG. 3, a sprint car 18 having a frame 330 supported in the rear by a rear axle 180 having a triangular carrier hub 310 at each end. A pair of torsion bars 320 are attached to one carrier hub 310 by a front swing arm 140 and a rear swing arm 350. FIG. 5 illustrates an air bag spring assembly 22 comprising an air spring 72 having a top cover 73 and self-sealing beads 80 mounted on a movable piston 66 over a cup 64 which is attached to a top mounting plate 58 on a terminal end of a trailing arm 56. FIG. 6 shows the aforementioned GOODYEAR™ air bag spring 1S6-023 as 24 in an air spring assembly 20 having a top cover 26 and a cup 28 secured by self-sealing tire beads 30.

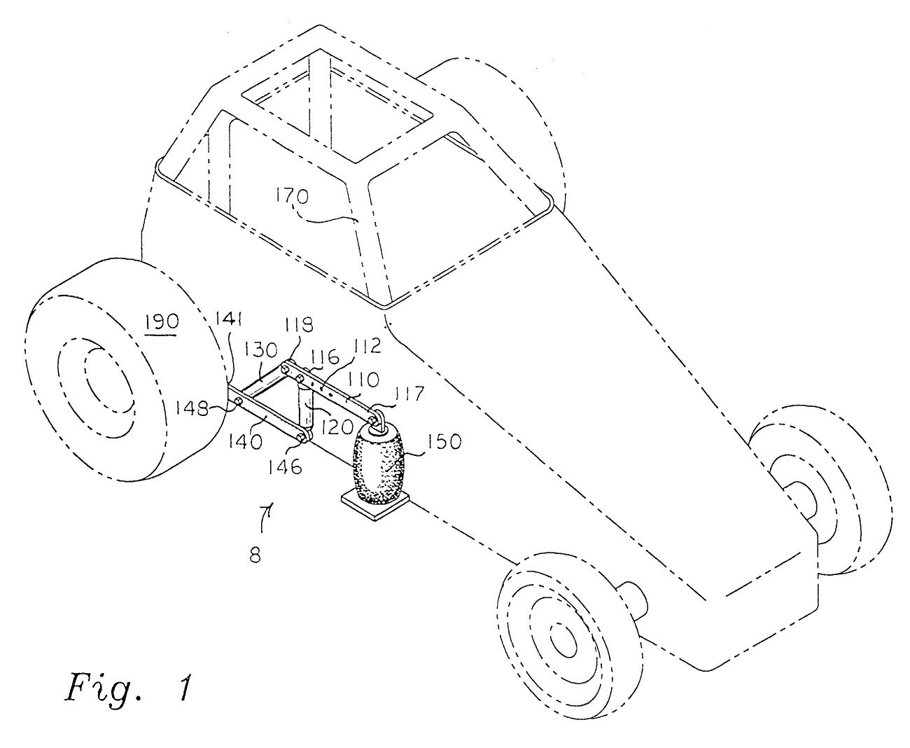

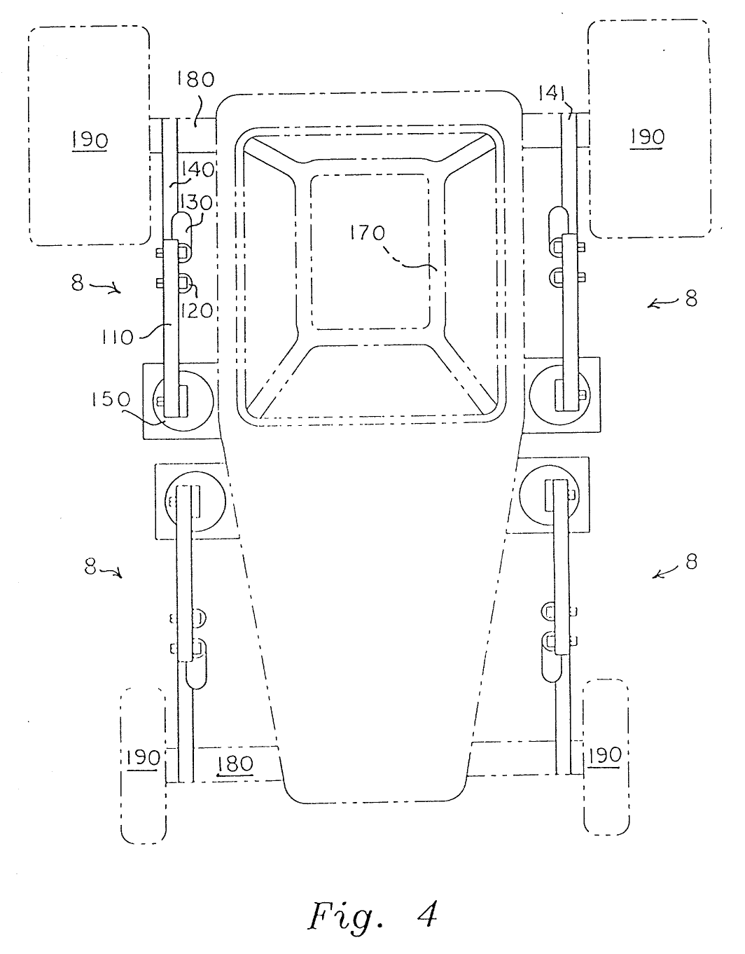

Turning to the first embodiment 8 of FIGS. 1, 2 and 4, an air bag spring 150 is draped over an inverted cone 160. Such air bag springs 150 are available through GOODYEAR™ or FIRESTONE™ with GOODYEAR™ bag number 1S6-023 serving as an optimal choice. A wide variety of air bags are available with varying size and stiffness. The cone 160 provides support toward shaping and holding up the air bag. The draped air bag provides a spring resistance to an input link of a four-bar linkage, having four pivot joints interconnecting the four bars. The appearance of first, second, third and fourth structural members may be described out of numerical sequence for the sake of brevity and the sake of understanding of functional relationships.

The input link has a first pivot point 116 and has an end 117 in contact with the air bag spring 150, the contact generally being located at the top of the air bag spring 150. The input link 110 is in rotational contact about a first pivot point 116 with the air bag spring 150, whereby substantially antagonistic oppositional forces from the air bag 150 are applied against the input link 110.

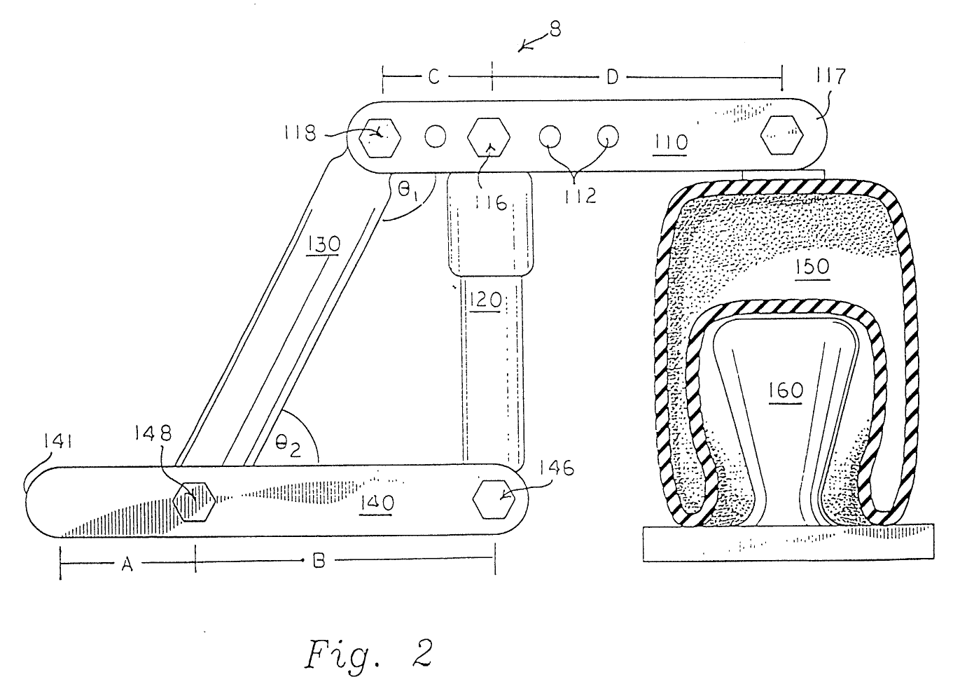

The input link 110 is attached, at the end 119 distant to the air bag, to a second pivot joint 118. Connected to the second pivot joint 118 is a second coupler link 130 functioning as a push rod. Between the air bag spring 150 and the second pivot-joint 118 is a first pivot joint 116. The first pivot joint 116 serves as a second fulcral point. Pivotally attached at the first pivot joint 116 is a first coupler link 120 functioning as a pull rod. At the end 121 (FIG. 2) of the first coupler link 120, distant the input link 110, is a third pivot joint 146 attached to the frame or chassis 170 of the vehicle. Also pivotally attached on the frame or chassis 170 at the third pivot joint 146 is a swing arm 140. The distant end 141 of the swing arm 140 is attached to a carrier hub 310 (FIG. 3) on the vehicle axle for live axles or half shafts, or directly to the axles for wheels not attached to rotating axles. This attachment to the carrier hub 310 or axle 180 will generally be a pivotal link (not shown). Orienting the swing arm 140 longitudinally parallel to the chassis and perpendicularly to the respective axle simplifies chassis construction and facilitates suspension adjustment and maintenance, though swing arms may be oriented in numerous other directions. The swing arm 140 has a fourth pivot joint 148 located between the third pivot joint 146 and the axle 180. Pivotally attached at the fourth pivot joint 148 is the push rod coupler link 130.

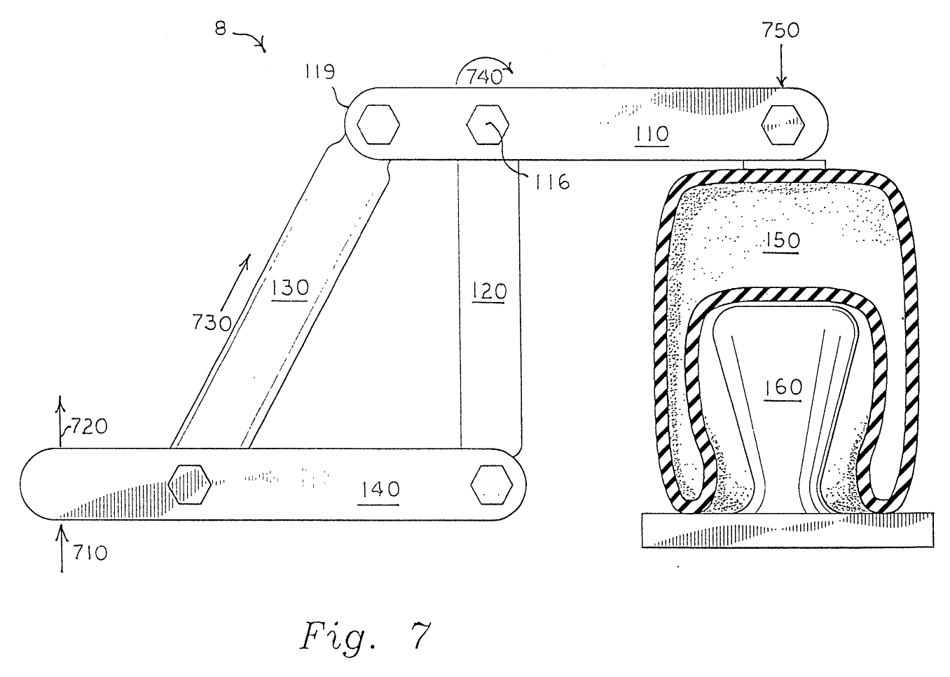

Referring to FIG. 7 showing relative force vectors to describe the invention's action and reaction, a rise in the wheel relative to the chassis typically occurs due to an upward force 710 at the ground, resulting from factors such as (1) a rise in the surface such as a bump or hill, (2) a downward force on the chassis as the bottom of a hill, trough, or hole, (3) the chassis rolling in the direction of the wheel during a corner, and (4) acceleration (rear wheels) or deceleration (front wheels). The forced rise in the wheel in turn forces (at 720) the swing arm 140 up at the axle connection, which in turn pushes (at 730) the push rod 130 up. The push rod 130 then pushes the attached end 119 of the input link 110 up, which forcibly pivots (at 740) the input link 110 about the first fulcral point (first pivot joint 116) resulting in the end of the input link 110 pressing down (at 750) in contact with the air bag spring 150. The force 750 acts downwardly, allowing the arm of the input link 110 to continue to pivot until the opposing force vector associated with pressure in the air bag spring 150 is equalized. In other words, the rotational force from the input link 110 is antagonistically counteracted such that the forces come into balance and into fulcral equilibrium.

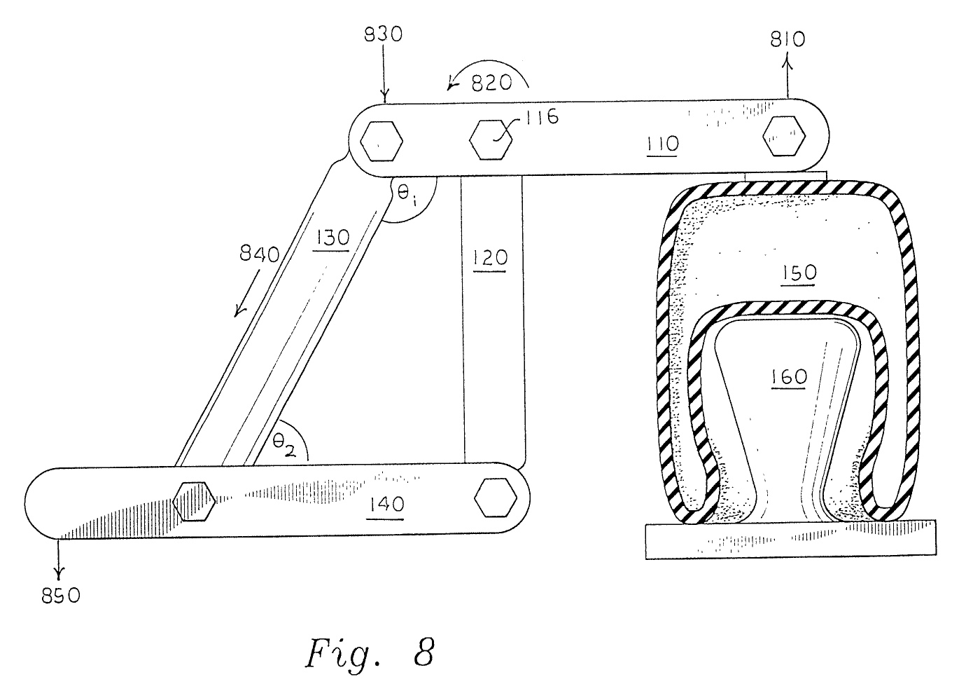

Alternately, as suggested by FIG. 8, weight may be transferred from the wheel 190 (not shown) as the road drops away from it, such as by entering a hole, cresting a bump or hill, or the car rolling away from the wheel 190 during cornering, deceleration (rear wheels), or acceleration (front wheels). Such events all may result in a reduction in upward force at the wheel. This reduction in weight on the wheel permits the air bag to force (at 810) the arm of the input link 110 up, forcibly rotating (at 820) the input link 110 about the first fulcral point 116, thereby transferring force along vector 830 down on the end of the input link 110, opposite the force vector 810 of the expanding air bag spring 150. This in turn results in a force 840 longitudinally directed down the push rod 130, thereby forcing (at 840) the swing arm 140 down. This force 840 in turn exerts a transferred downward force 850 onto the axle 180 (not shown), until such point as the force 810 exerted by the air bag spring 150 and the upward wheel force 710 are fulcrally balanced in equilibrium.

Additionally, the four-bar linkage achieves a positional offset for the point of contact with the air bag spring 150. This permits the input link 110 of the four-bar linkage to come in contact with the air bag spring 150 at a point well clear of the ground.

As depicted in FIGS. 1 and 2, the four-bar linkage provides a means for adjusting spring coefficients independent of air pressure and air bag changes. The four-bar linkage can be used to increase or decrease the effective spring coefficient as seen at the axle by adjusting the travel of the input link adjoining the air bag. The effective spring coefficient is adjusted by the following equation with the angles and distances depicted in FIG. 2.

F_{effective}=(F_{actual})×((A+B)/B)×[cos (theta 1)]×([C/D) cos (theta 2)]

where:

A=the distance between the wheel center and the fourth pivot joint 148;

B=the distance between third pivot joint 146 and the fourth pivot joint 148;

C=the distance between the first pivot joint 116 and the second pivot joint 118;

D=the distance between the first pivot joint 116 and the air bag spring 150;

Theta 1=the angle formed by the swing arm 140 and the second coupler link 130 closest the air bag spring 150 about the inside of the fourth pivot joint 148; and

Theta 2=the inside angle formed by the second connector link 130 and the input link 110 closest the air bag spring 150 about the inside of the third pivot joint 118.

The linkage adjustments increase or reduce the force maintained on the axle with respect to axle travel. The linkage adjustment may be readily facilitated by drilling a plurality of holes 112 (FIGS. 1 and 2) in the input link 110 and repositioning the first pivot joint 116, or fulcral point which in turn adjusts variables C, D and Theta 2.

As a portion of the spring character of the airbag is obtained through air-compression and expansion, the airbag provides a non-linear resistance to the arm travel, thus creating an inherently damped spring due to energy losses associated with compression and expansion of gases.

Due to the relatively low viscosity of air, an airbag has a higher and broader frequency response than traditional dampening devices such as shock absorbers using high viscosity fluids. This results in a smaller portion of the high speed vibrations that are likely to be found on bumpy surfaces such as dirt courses to transfer via the suspension to the chassis as the suspension will flex with these high speed movements as contrasted with the slower suspension systems. Likewise, high frequency Fourier components of individual pulses and movements may be readily transferred to the air bag spring 150, thereby resulting in lesser values for the derivatives of the displaced wheel distance with respect to time, such as acceleration and jerks, over the course of the travel of the swing arm 140.

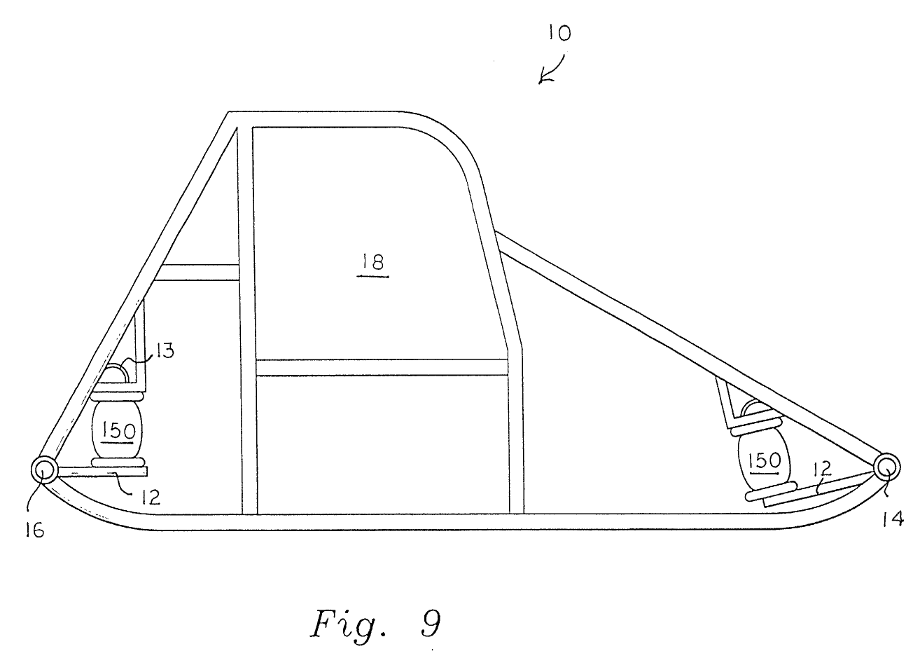

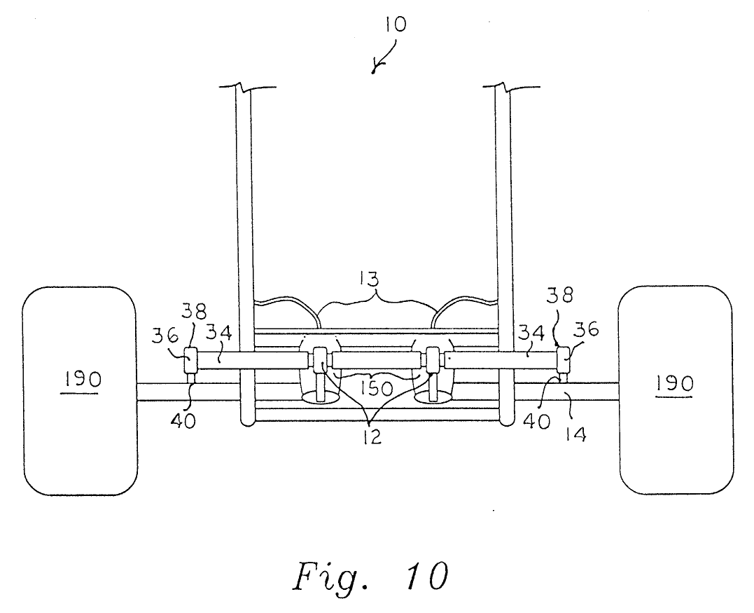

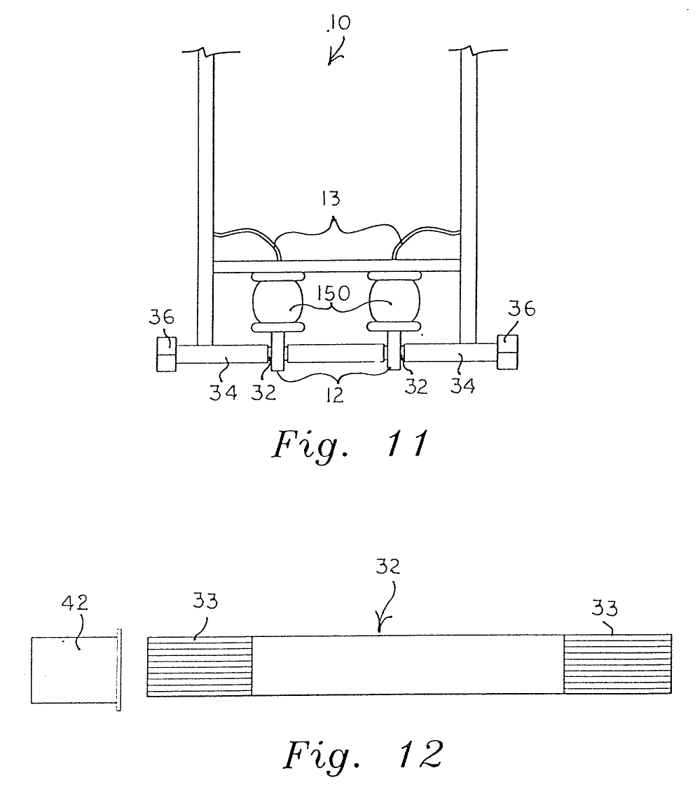

The second embodiment 10 illustrated in FIGS. 9-11 employs a first inside actuator arm 12 acting on an air bag spring 150 pressurized by an air hose 13 for each wheel 190 on the front axle 14 and the rear axle 16 of a sprint car 18. The first inside actuator shaft 12 has a distal end connected directly to a hollow rotating actuator shaft 32 housed inside a horizontal frame tube 34 consisting of three separate frame supported sections. A second outside actuator arm 36 has a first end 38 connected to the housing of the axle 14 or 16 and a second end 40 connected to an outside end of the rotating actuator shaft 32. The inside actuator arm 12 is provided with a splined hole which is slotted at the end of the arm for clamping with a bolt (not shown) onto one of the splined ends 34 of the rotating hollow shaft actuator shaft 32 and further protected by a bushing 42 as shown in FIG. 12. The inside actuator arm 12 can have a series of holes for saving weight (not shown).

An additional frame element 44 can be provided for supporting the air bag spring 150 on top and a circular support plate 46 on the bottom which is attached to the first inside actuator arm 12. Thus, the second embodiment system 10 again provides a lightweight but durable suspension system for a sprint car.

It should be noted that there is both a reduction in weight associated with the use of an airbag spring over metal coil or torsion springs and a reduction in unsprung weight, both of which will improve the handling of the vehicle.

It is to be understood that the present invention is not limited to the embodiments described above, but encompasses any and all embodiments within the scope of the following claims.

We claim:

1. An air bag suspension system for a vehicle frame comprising:
a vehicle frame;
a swing arm, having a first end and a second end, said first end of swing arm pivotally attached to said vehicle frame;
a wheel attachment means attached to the second end of the swing arm comprising:
an input link having a first end, a second end, and a middle portion;
a first coupler link having a first end and a second end;
a second coupler link having a first end and a second end;
wherein said swing arm has a middle portion;
the first end of the input link forcibly abuts the air bag spring;
the middle of said input link is pivotally connected to the first end of the second coupler link;
the second end of the input link is pivotally coupled to the first end of the second coupler link;
the second end of the first coupler link is pivotally connected to the frame and the first end of the swing arm; and
the second end of the second coupler link is pivotally connected to the middle portion of the swing arm; and
an air bag spring positioned to be fulcrally operative on the swing arm with said pivot point positioned between the airbag and the wheel attachment means.

2. The air bag suspension system according to claim 1, further comprising a cone with said air bag draped over the cone, wherein said cone has a base which is positioned above its tip.

3. The air bag suspension according to claim 1, wherein said air bag suspension system is on a sprint car.

4. An air bag suspension system for each wheel on an axle of a sprint car comprising:
an air spring bag;
a first inside actuator arm having a proximate end and a distal end being attached to a bottom of said air spring bag at a proximate end;
a second outside actuator arm having a proximate end and a distal end being attached to an axle housing of the sprint car at a proximate end;
a rotatable actuator shaft having a distal end and a proximate end being connected at a distal end to the proximate end of the outside actuator arm and at a proximate end to the distal end of said first inside actuator arm; and
a horizontal frame tube formed in three sections to house the rotatable actuator shaft.

5. The air bag suspension system according to claim 4, wherein the distal end of the inside actuator arm has a splined and slotted hole and a bolt for attachment to the proximate end of the rotatable actuator shaft.

6. The air bag suspension system according to claim 4, wherein the rotatable actuator shaft is hollow and has splined ends.

7. The air bag suspension system according to claim 4, wherein the proximate end of the rotatable actuator shaft has a bushing.

8. The air bag suspension system according to claim 4, wherein the inside actuator arm has additional holes for minimizing the weight of the arm and the air bag suspension system.

9. The air bag suspension system according to claim 4, wherein the air spring bag has an air hose for inflation.
